(19) United States
(12) Patent Application Publication
(10) Pub. No.: US 2026/0145104 A1
(43) Pub. Date: May 28, 2026

(54) DISCHARGE CLOSURE ELEMENT FOR A FILTER SYSTEM, FILTER ELEMENT, AND FILTER SYSTEM

(71) Applicant: MANN+HUMMEL GmbH, Ludwigsburg (DE)

(72) Inventor: Günter JOKSCHAS, Murrhardt (DE)

(21) Appl. No.: 19/414,920

(22) Filed: Dec. 10, 2025

Related U.S. Application Data
(63) Continuation of application No. PCT/EP2024/067664, filed on Jun. 24, 2024.

(30) Foreign Application Priority Data
Jul. 7, 2023 (DE) 10 2023 117 938.1

(51) Int. Cl. B01D 35/147; B01D 35/16

(52) U.S. Cl. CPC B01D 35/147; B01D 35/16; B01D 2201/347; B01D 2201/4084

(57) ABSTRACT

A drain closure element has an element body connectable to a filter housing of a filter system and a bypass valve closing a drain opening of the element body. A filter element for the filter system has a filter medium surrounding an element interior and an end disc connected to the filter medium. The end disc has an element drain opening. A first seal element oriented radially inwardly surrounds the element drain opening which is closable by the drain closure element. The first seal element seals against a first seal surface of the drain closure element. The end disc has a receiving section surrounding the element drain opening for guiding the drain closure element. The receiving section has a second seal element sealing against a seal surface of the filter housing and a third seal element sealing against a second seal surface of the drain closure element.

### CROSS-REFERENCE TO RELATED APPLICATIONS

This application is a continuation application of international application No. PCT/EP2024/067664 having an international filing date of June 24, 2024, and designating the United States, the international application claiming a priority date of July 7, 2023, based on prior filed German patent application No. 102023117 938.1, the entire contents of the aforesaid applications being incorporated herein by reference.

### BACKGROUND

The invention concerns a discharge closure element for a filter system as well as a filter element and a filter system for filtering a fluid, for example oil or fuel, for example of an internal combustion engine.

In filter housings of openable suspendedly arranged filter systems, it is necessary that, prior to unscrewing the housing cover, for example, when servicing the filter system, a drain opening is opened so that the liquid contained in the housing may drain. For this purpose, filters are usually provided with closure plugs or the like. For sealing the raw side and the clean side, these closure plugs each require a seal, for example, an O-ring. A combination of a closure plug with an additional function, for example, a bypass valve, requires also additional seals for sealing in relation to the filter housing.

A filter system for a fluid, for example oil, fuel, water or air, for example of an internal combustion engine, for example of a motor vehicle, is known from WO 2014/082762, with a filter housing which includes a fluid inlet and a fluid outlet and in which a filter element is arranged such that it separates the fluid inlet from the fluid outlet. Furthermore, the filter system includes a drain device for fluid contained in the filter housing which includes a housing drain opening which is closable by a closure means. A separation element which separates a clean fluid side of the filter element from a raw fluid side includes an element drain opening which is closable by the closure means. By means of the closure means, the housing drain opening and the element drain opening are thus closed in the closed state of the drain device.

WO 2019/120976 describes a filter element of a filter for liquid, for example oil or fuel, for example of an internal combustion engine, for example of a motor vehicle, with a filter medium which circumferentially contiguously surrounds an element interior in relation to a virtual axis and which is connected to an end member at at least one axial end face in relation to the axis. In this context, the end member includes a filter element emptying opening, which surrounds the axis and is connected to the element interior, and a filter element seal surface or filter element sealing surface of a filter element seal device, which circumferentially contiguously surrounds the filter element emptying opening and by means of which the filter element emptying opening may be closed when the filter element is assembled. The filter element seal device includes at least one circumferentially contiguous seal in relation to the axis which is fastened on the part of the filter element.

WO 2019/120981 describes a similar filter element in which the filter element seal surface or filter element sealing surface is oriented axially with at least one directional component in relation to the axis.

EP 2072103 A1 discloses a filter element for an oil filter of an internal combustion engine, for example for motor vehicles, in which the filter element includes a filter bypass valve fastened thereat in such a way that the filter element together with the filter bypass valve forms a constructive unit provided for common exchange. The filter bypass valve is connected fixedly to the filter element so that the user is forced to exchange the filter bypass valve together with the filter element during regular servicing work.

### SUMMARY

It is an object of the invention to provide a drain closure element, improved in respect to a drain solution, for a filter system for filtering a fluid, for example oil or fuel, for example of an internal combustion engine.

A further object of the invention is to provide a filter element, improved in respect to a drain solution, for a filter system for filtering a fluid, for example oil or fuel, for example of an internal combustion engine.

A further object resides in providing a filter system, improved in respect to a drain solution, for filtering a fluid, for example oil or fuel, for example of an internal combustion engine, with such a filter element.

The aforementioned object is solved according to an aspect of the invention by a drain closure element for a filter system for filtering a fluid, for example oil or fuel, for example of an internal combustion engine, including an element body connectable to a filter housing of the filter system by means of a rotation and/or plug-in movement in relation to a longitudinal axis, wherein the element body includes a drain opening which is closable and/or closed by a bypass valve.

In a preferred embodiment, the drain closure element or a combination of the drain closure element with an additional component, for example, a bypass valve, includes no additional seal. The sealing action of the filter system is realized in this embodiment by the seals attached to the filter element which are therefore exchanged upon exchange of the filter element. The drain closure element is thus easy to manufacture because no seal grooves must be provided and is robust in respect to damages. The drain closure element does not need to be exchanged when exchanging the filter element and may be reused after filter exchange because the relevant seals are renewed by exchanging the filter element. In this way, also a shorter servicing time is possible and the risk of damages may also be significantly minimized.

According to a further aspect of the invention, the further object is solved by a filter element for a filter system for filtering a fluid, for example oil or fuel, for example of an internal combustion engine, with at least one filter medium which surrounds an element interior and is connected to an end disc at least at one axial end face in relation to a longitudinal axis, wherein the end disc includes an element drain opening which is connected in fluid communication to the element interior and includes at least one first seal element, surrounding the element drain opening and oriented radially inwardly, and which, when installed in a filter housing of the filter system as intended, is closable and/or closed by a drain closure element arranged at a housing part of the filter housing, wherein the first seal element is configured to seal-tightly contact a first seal surface of the drain closure element, wherein the end disc includes a receiving section which is configured to guide the drain closure element and which surrounds the element drain opening circumferentially and which includes at least one second circumferential seal element, which, when installed in the filter housing as intended, seal-tightly contacts a seal surface of the housing part, wherein the receiving section includes at least one third circumferential seal element which seal-tightly contacts a second seal surface of the drain closure element.

According to a further aspect of the invention, the further object is solved by a filter system for filtering a fluid, for example oil or fuel, for example of an internal combustion engine, with a filter housing including at least one fluid inlet and at least one fluid outlet and in which a filter element is arranged such that it separates the at least one fluid inlet from the at least one fluid outlet, and with a drain device for fluid contained in the filter housing, which includes at least one housing drain opening, which in operation as intended is closable and/or closed by a drain closure element, wherein the filter element includes at least one filter medium which surrounds an element interior and which is connected at least at one end face to an end disc, wherein the end disc includes an element drain opening which is connected to the element interior and is closable and/or closed by the drain closure element in operation as intended.

Embodiments and advantages of the invention result from the further description and the accompanying drawings.

According to one aspect of the invention, a drain closure element for a filter system for filtering a fluid, for example oil or fuel, for example of an internal combustion engine, is proposed, including an element body which is connectable to a filter housing of the filter system by means of a rotation and/or plug-in movement in relation to a longitudinal axis. In this context, the element body includes a drain opening which is closable and/or closed by a bypass valve.

The proposed drain closure element serves to close an element drain opening of the filter element. The fluid contained in the filter element may drain via the element drain opening when exchanging the filter element. The drain closure element closes further a housing drain opening of the filter housing of the filter system.

The drain closure element includes an integrated bypass valve. Due to the bypass valve, the raw fluid, at high hydraulic pressure at the raw fluid side, may flow unfiltered through the drain closure element and the bypass valve integrated therein to the clean fluid side of the filter element and drain through the fluid outlet of the filter system in this way.

The bypass valve is thus arranged at the reusable drain closure element and need not be exchanged also when exchanging the filter element.

When the drain closure element is slowly unscrewed from the filter housing, in a first step initially only the housing drain opening is opened and the raw fluid contained in the filter housing is drained. Only upon further unscrewing of the drain closure element, then also the element drain opening is opened so that the filtered clean fluid contained in the filter element is also drained.

The filter element may include all seal elements in order to seal in relation to the drain closure element. When exchanging the filter element, all seal elements are also exchanged at the same time. The drain closure element may thus be reused.

According to an embodiment of the drain closure element, the bypass valve may be formed at least partially as one piece with the element body. In this manner, the bypass valve may be integrated into the drain closure element.

According to an embodiment of the drain closure element, the bypass valve may include a valve body which is movable linearly against a pressure spring and which, by means of the pressure spring, is pressed into a valve seat, wherein the pressure spring is supported against a pressure surface arranged at the element body. In this way, the bypass valve may be designed as a mushroom valve.

According to an embodiment of the drain closure element, the valve body may be guided at a linear guide which is connected to the element body and is for example molded to the element body. In this way, the bypass valve may be manufactured inexpensively.

According to an embodiment of the drain closure element, the element body may include a first seal surface for sealing against a seal element of an element drain opening of a filter element of the filter system and a second seal surface for sealing against a seal element of a receiving section of the filter element, wherein the seal surfaces circumferentially surround the longitudinal axis, respectively. In this way, the drain closure element may seal-tightly close the element drain opening of the filter element and the housing drain opening of the filter housing.

According to an embodiment of the drain closure element, the element body may include a connection part and a centering part, wherein the centering part includes the first seal surface and the connection part the second seal surface. In this manner, the drain closure element may seal-tightly close the element drain opening of the filter element and the housing drain opening of the filter housing.

In particular, the centering part may be connected to the connection part so as to be movable, for example axially limited, along the longitudinal axis. In this context, the connection part and the centering part may include for example complementary connecting elements of the connection, for example of a snap-on connection, which permits, for example an axially limited movement of the centering part along the longitudinal axis in relation to the connection part. Such a movement of the centering part toward the connection part may be advantageous in use of the filter element if strong pressure pulsations may occur when filtering the fluid. Such pulsations may be damaging to the first seal element at the clean side of the filter element.

A drain channel guided to an exterior side of the filter housing when arranged as intended may be present. In particular, the drain channel may be present in the connection part in this context. After partial unscrewing of the drain closure element from the filter housing, raw fluid contained in the filter housing may drain via the drain channel.

According to a further aspect of the invention, a filter element for a filter system for filtering a fluid, for example oil or fuel, for example of an internal combustion engine, is proposed, with at least one filter medium, which surrounds an element interior and which is connected to an end disc at at least one axial end face in relation to the longitudinal axis. The end disc includes an element drain opening which is connected in fluid communication to the element interior and includes at least one first seal element, which surrounds the element drain opening and which is radially inwardly oriented, and which, when installed as intended in a filter housing of the filter system, is closable and/or closed by a drain closure element arranged at a housing part of the filter housing. The first seal element is configured to contact seal-tightly a first seal surface of the drain closure element. In this context, the end disc includes a receiving section which is configured to guide the drain closure element, which surrounds the element drain opening circumferentially, and which includes at least one second circumferential seal element which, when installed in the filter housing as intended, seal-tightly contacts a seal surface of the housing part. The receiving section includes at least one third circumferential seal element which seal-tightly contacts a second seal surface of the drain closure element.

The proposed filter element includes an element drain opening in order to permit the fluid contained in the filter element to drain when exchanging the filter element. This element drain opening may be closed by a drain closure element which, at the same time, closes a housing drain opening. The filter element includes all seal elements in order to seal against the drain closure element. When exchanging the filter element, all seal elements are thus exchanged also at the same time. In this context, the drain closure element may be reused.

The seal elements may be but are not necessarily O-rings. For example, the first seal element may be arranged at the end disc and may be formed as a plastic lip from the material of the end disc. The other seal elements may however be present being cut from plastic material. The seal elements may be present as O-rings, molded on or be embodied as a seal with two lips.

The drain closure element may include an integrated bypass valve. Due to the bypass valve, the raw fluid, at high hydraulic pressure at the raw fluid side, may flow unfiltered through the drain closure element and the bypass valve integrated therein to the clean fluid side of the filter element and in this way drain through the fluid outlet of the filter system.

The bypass valve is thus arranged at the reusable drain closure element and need not be exchanged when exchanging the filter element.

When the drain closure element is unscrewed slowly from the filter housing, in a first step initially only the housing drain opening is opened and the raw fluid contained in the filter housing is drained. Only upon further unscrewing of the drain closure element, the element drain opening is then also opened so that filtered clean fluid contained in the filter element is also drained.

According to an embodiment of the filter element, the first, second, and third seal elements may be configured as radially sealing seal elements. In this way, a reliable sealing action of the drain closure element in relation to the filter element and the filter housing may be realized.

According to an embodiment of the filter element, the second seal element may be arranged at the radially outer side of the receiving section and the third seal element at a radially inner side of the receiving section. In this way, the second seal element may seal against the filter housing and the third seal element against a radially inwardly positioned contour of the drain closure element.

In an alternative embodiment, the second and third seal elements may be arranged on a radially outer side of the receiving section. In this way, the second seal element may seal against the filter housing and the third seal element against a radially outwardly positioned contour of the drain closure element.

According to an embodiment of the filter element, one of the second and third seal elements may be arranged at a larger radial distance to the longitudinal axis than the other one of the second and third seal elements. In this way, a beneficial mounting of the drain closure element as well as an effective sealing action of the filter element and of the drain closure element in the filter housing is possible. In this context the second seal element may be arranged at the radially outer side of the receiving section and the third seal element at a radially inner side of the receiving section.

According to an embodiment of the filter element, the second seal element may be arranged at the same level of the longitudinal axis as the third seal element, or the second seal element may be arranged between the first seal element and the third seal element along the longitudinal axis. An arrangement at the same level of the longitudinal axis is advantageous when the second seal element is arranged at the radially outer side and the third seal element at the radially inner side of the receiving section. For reasons of geometry of the arrangement of receiving section and drain closure element in the filter housing, an arrangement at different levels may however also be beneficial.

According to an embodiment of the filter element, the receiving section may be connected to the end disc so as to be movable, for example axially limited, along the longitudinal axis. In this context, the receiving section and the end disc may for example include complementary connection elements of a connection, which permits, for example an axially limited movement of the receiving section along the longitudinal axis relative to the end disc. Such a movement of the receiving section toward the filter element may be advantageous in use of the filter element if strong pressure pulsations may occur when filtering the fluid. Such pulsations may be damaging to the first seal element at the clean side of the filter element.

According to an embodiment of the filter element, the first seal element may be integrated into the end disc. In this context, the first seal element may be for example, designed as one piece together with the end disc. In this way, the first seal element may be manufactured efficiently. In this way, a reliable sealing action against the drain closure element may be also provided.

According to a further aspect of the invention, a filter system for filtering a fluid, for example oil or fuel, for example of an internal combustion engine, is proposed, with a filter housing which includes at least one fluid inlet and at least one fluid outlet and in which a filter element is arranged such that it separates the at least one fluid inlet from the at least one fluid outlet. Furthermore, the filter system includes a drain device for fluid contained in the filter housing which includes at least one housing drain opening which, in operation as intended, is closable and/or closed by a drain closure element. The filter element includes at least one filter medium which surrounds an element interior and which at least at one end face is connected to an end disc. In this context, the end disc includes an element drain opening which is connected in fluid communication to the element interior and, in operation as intended, is closable and/or closed by the drain closure element.

The filter element of the proposed filter system includes an element drain opening in order to allow the fluid contained in the filter element to drain when exchanging the filter element. This element drain opening may be closed by a drain closure element which at the same time closes a housing drain opening. The filter element includes all seal elements in order to seal against the drain closure element. When exchanging the filter element, all seal elements are thus exchanged at the same time. In this context, the drain closure element may be reused.

The drain closure element may include an integrated bypass valve. Due to the bypass valve, the raw fluid, at high hydraulic pressure at the raw fluid side, may flow unfiltered through the drain closure element and the bypass valve integrated therein to the clean fluid side of the filter element and drain through the fluid outlet of the filter system in this way.

The bypass valve is arranged at the reusable drain closure element and need not be exchanged when exchanging the filter element.

The seal elements may be but not necessarily be O-rings. For example, the first seal element may be arranged at the end disc and may be formed as a plastic lip from the material of the end plate. The other seal elements may however be present being cut from plastic material. The seal elements may be present as O-rings, molded on or embodied as a seal with two lips.

When the drain closure element is unscrewed slowly from the filter housing, in a first step initially only the housing drain opening is opened and the raw fluid contained in the filter housing is drained. Only upon further unscrewing of the drain closure element, the element drain opening is then also opened so that filtered clean fluid contained in the filter element is also drained.

According to an embodiment of the filter system, the drain closure element may include an element body with a first seal surface for sealing against a seal element of the element drain opening of the filter element and a second seal surface for sealing against a seal element of a receiving section of the filter element, which each surround a longitudinal axis circumferentially. The drain closure element in relation to the longitudinal axis is connectable and/or connected to the filter housing by means of a rotation and/or plug-in movement. In this context, the element body includes a drain opening which is closable and/or closed by a bypass valve. By means of the drain closure element, the element drain opening and the housing drain opening may be seal-tightly closed and opened again. Due to the bypass valve, the raw fluid, at high hydraulic pressure at the raw fluid side, may flow unfiltered through the drain closure element and the bypass valve integrated therein to the clean fluid side of the filter element and drain through the fluid outlet of the filter system in this way.

According to an embodiment of the filter system, the bypass valve may be configured at least partially as one piece together with the element body. In this manner, the bypass valve may be integrated into the drainage closure element.

According to an embodiment of the filter system, the bypass valve may include a valve body which is movable linearly against a pressure spring and which, by means of the pressure spring, is pressed into a valve seat, wherein the pressure spring is supported against a pressure surface arranged at the element body. In particular, the valve body may be guided in this way at a linear guide which is connected to the element body, for example molded to the element body. In this way, the bypass valve may be designed as a mushroom valve and may be manufactured efficiently.

According to an embodiment of the filter system, the element body may include a connection part and a centering part, wherein the centering part includes the first seal surface and the connection part the second seal surface. In this way, the drain closure element may seal-tightly close the element drain opening of the filter element and the housing drain opening of the filter housing.

According to an embodiment of the filter system, the centering part may be connected to the connection part so as to be movable, for example axially limited, along the longitudinal axis. In particular, in this context the connection part and the centering part may include complementary connection elements of a connection which permits, for example an axially limited movement of the centering part along the longitudinal axis relative to the connection part. Such a movement of the centering part along the longitudinal axis relative to the connection part may be advantageous in use of the filter element if strong pressure pulsations occur upon filtering of the fluid. Such pulsations may be damaging to the first seal element at the clean side of the filter element.

A drain channel guided to an exterior side of the filter housing when arranged as intended may be present. In particular, the drain channel may be present in the connection part in this context. After partial unscrewing of the drain closure element from the filter housing, raw fluid contained in the filter housing may drain via the drain channel which may be for example arranged in the drain closure element.

### BRIEF DESCRIPTION OF THE DRAWINGS

Further advantages result from the following detailed description of embodiments and the accompanying drawings. In the drawings, exemplary embodiments of the invention are illustrated. The drawings and the description contain numerous features in combination. A person of skill in the art will consider the features expediently also individually and combine them to expedient further combinations and embodiments.

FIG. 1 shows an isometric illustration of a filter system for filtering a fluid, for example oil or fuel, for example of an internal combustion engine, according to an embodiment of the invention.

FIG. 2 shows an isometric illustration of the filter system according to FIG. 1 without an upper housing part.

FIG. 3 shows a section illustration of the filter system according to FIG. 2.

FIG. 4 shows a section illustration of a filter element according to an embodiment of the invention.

FIG. 5 shows a section illustration of a drain closure element according to an embodiment of the invention.

FIG. 6 shows a section illustration of a filter system according to a further embodiment of the invention.

FIG. 7 shows an enlarged illustration of a region of a drain device of the filter system according to FIG. 6.

### DETAILED DESCRIPTION

In the drawing figures, same or same-type components are identified with like reference characters. The drawing figures show only examples and are not to be understood as limiting.

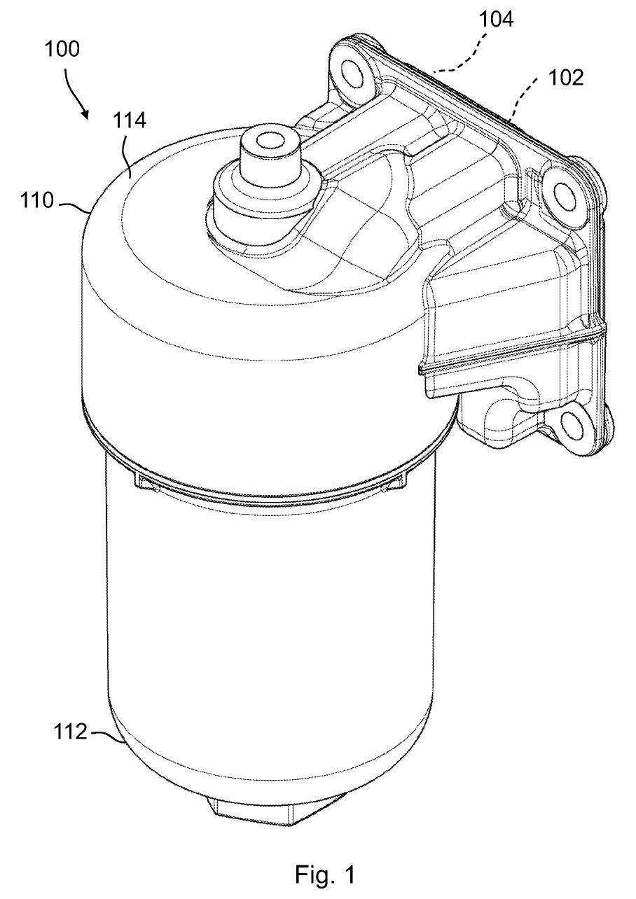

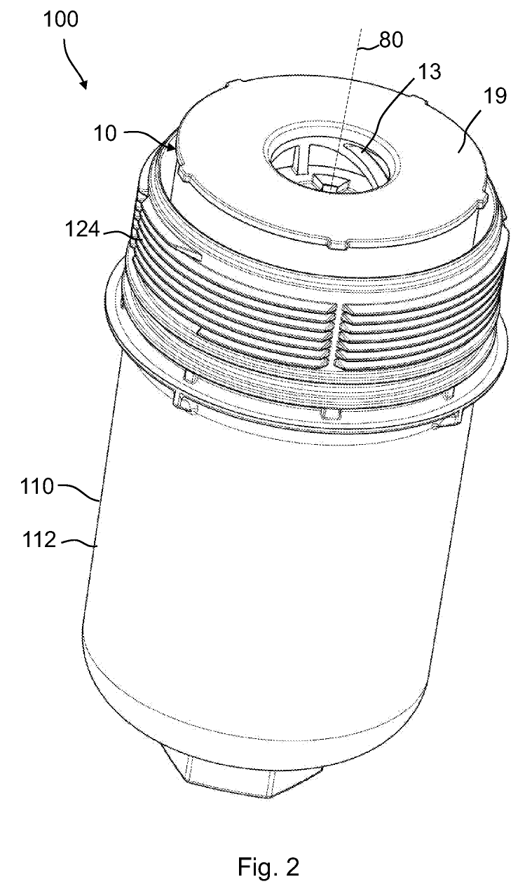

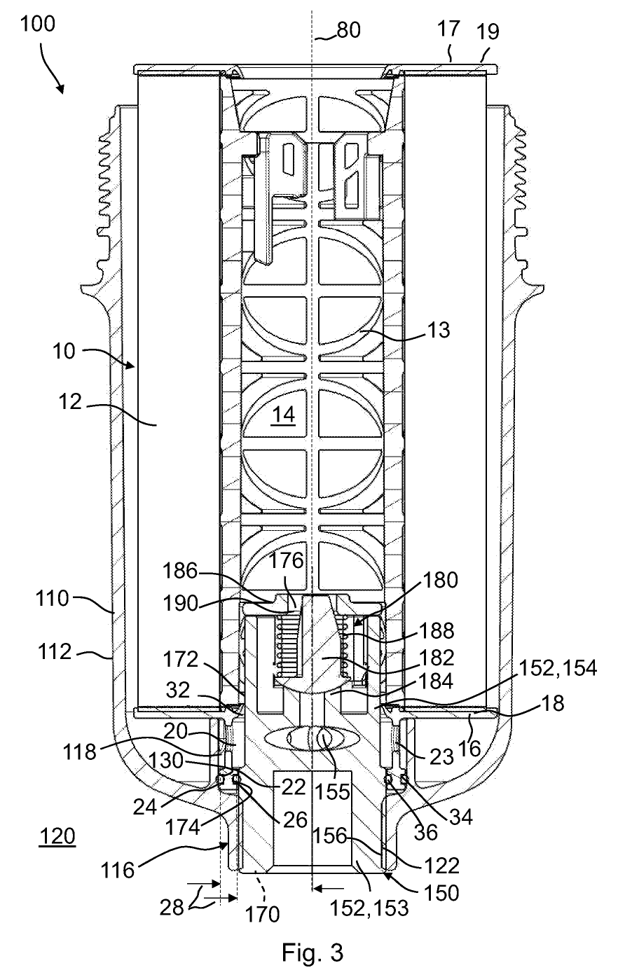

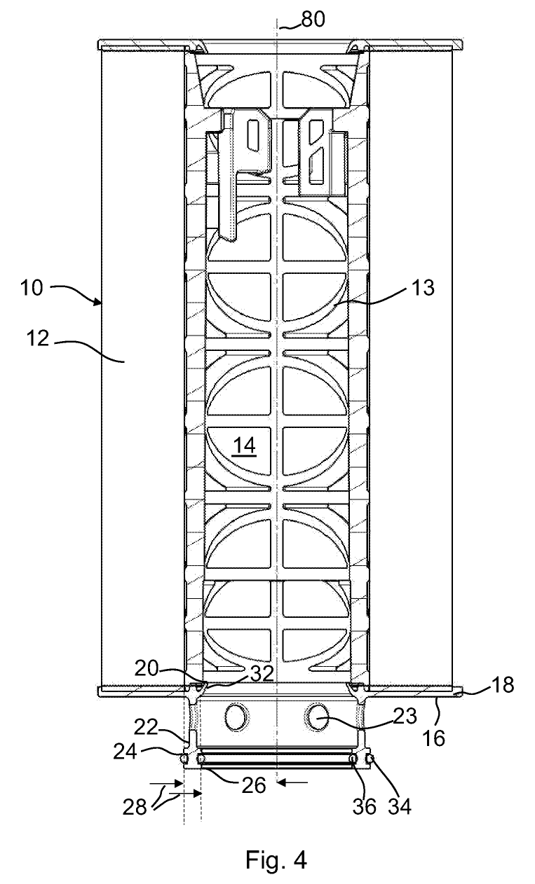

For explaining the invention, FIG. 1 shows an isometric illustration of a filter system 100 for filtering a fluid, for example oil or fuel, for example of an internal combustion engine, according to an embodiment of the invention. FIG. 2 shows an isometric illustration of the filter system 100 according to FIG. 1 without an upper housing part 114. In FIG. 3, a section illustration of the filter system 100 according to FIG. 2 is illustrated, while FIG. 4 shows a section illustration of the filter element 10.

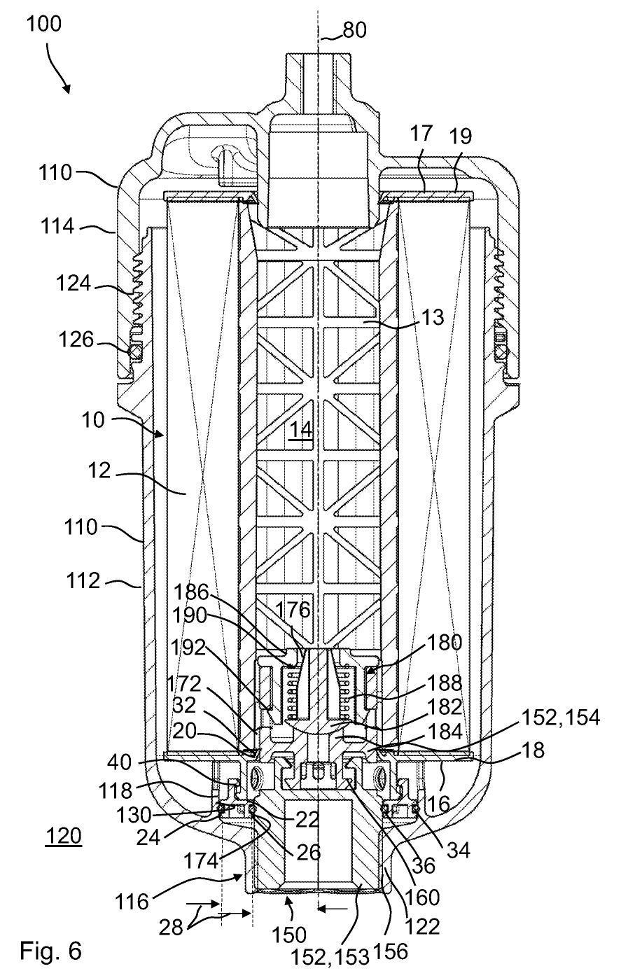

The filter system 100 comprises a filter housing 110 with two housing parts 112, 114 which are connected by a screw thread 124. The two housing parts 112, 114 are seal-tightly closed by means of a housing seal 126 (see FIG. 6), for example, an O-ring. The second housing part 114 comprises a fluid inlet 102 and a fluid outlet 104. In the filter housing 110, a filter element 10 is arranged such that it separates the at least one fluid inlet 102 from the at least one fluid outlet 104.

The filter system 100 comprises a drain device 116 for fluid contained in the filter housing 110 which comprises a housing drain opening 118 which, in operation as intended, is closable and/or closed by a drain closure element 150.

The drain closure element 150 may be connected to the filter housing 110 by means of a rotation and/or plug-in movement in relation to the longitudinal axis 80. For this purpose, the drain closure element 150 comprises an outer thread 156 and the housing part 114 of the filter housing 110 an inner thread 122.

The filter element 10 comprises a filter medium 12 which surrounds an element interior 14 and which is connected to end discs 18, 19 at the axial end faces 16, 17. The filter medium 12 is mechanically supported at its inner side against the hydraulic pressure of the flowing fluid by a support tube 13.

Raw fluid flowing in through the fluid inlet 102 flows tangentially against the filter element 10, passes through the filter medium 12 of the filter element 10 into the element interior 14, and exits the filter element 10 through the axially arranged fluid outlet 104.

The end disc 18 comprises an element drain opening 20 which is connected in fluid communication to the element interior 14 and comprises at least one first seal element 32 surrounding circumferentially the element drain opening 20 and oriented radially inwardly. When the filter element 10 is installed as intended in the filter housing 110 of the filter system 100, the element drain opening 20 is closable and/or closed by the drain closure element 150 arranged at the housing part 112 of the filter housing 110. In this context, the first seal element 32 is designed to seal-tightly contact the first seal surface 172 of the drain closure element 150.

The first seal element 32 is integrated into the end disc 18. In particular, the first seal element 32 may be designed as one piece together with the end disc 18 in this context.

The end disc 18 comprises a receiving section 22 which is embodied for guiding the drain closure element 150. The receiving section 22 circumferentially surrounds the element drain opening 20 and comprises a second circumferential seal element 34 which, when installed as intended in the filter housing 110, seal-tightly contacts a seal surface 130 of the housing part 112. The receiving section 22 comprises a third circumferential seal element 36 which seal-tightly contacts a second seal surface 174 of the drain closure element 150.

As seen for example in FIG. 3, the drain closure element 150 comprises an element body 152 with the first seal surface 172 for sealing against the seal element 32 of the element drain opening 20 of the filter element 10 and with the second seal surface 174 for sealing against the seal element 36 of the receiving section 22 of the filter element 10. The seal surfaces 172, 174 circumferentially surround the longitudinal axis 80, respectively.

The first, second, and third seal elements 32, 34, 36 are configured as radially sealing seal elements 32, 34, 36.

The second seal element 34 is arranged at the radially outer side 24 of the receiving section 22 and the third seal element 36 is arranged at a radially inner side 26 of the receiving section 22.

In an alternative embodiment, not illustrated, the second and third seal elements 34, 36 could however also be arranged at the radially outer side 24 of the receiving section 22. For this purpose, the contour of the connection part 153 would have to be changed also and comprise a radially outwardly arranged and a radially inwardly oriented seal surface 174.

The second seal element 34 is arranged at a larger radial distance 28 to the longitudinal axis 80 than the third seal element 36.

Furthermore, the second seal element 34 is arranged at the same level of the longitudinal axis 80 as the third seal element 36.

In an alternative embodiment, not illustrated, the second seal element 34 could also be arranged however between the first seal element 32 and the third seal element 36 along the longitudinal axis 80.

As seen in FIG. 4, the first seal element 32 is molded to the end disc 18 and thus connected to the end disc 18 as one piece. The second and the third seal elements 34, 36 are arranged at the receiving section 22 connected to the end disc 18. Accordingly, the first, second, and third seal elements 32, 34, 36 are connected to the filter element 10 and are exchanged when exchanging the filter element 10.

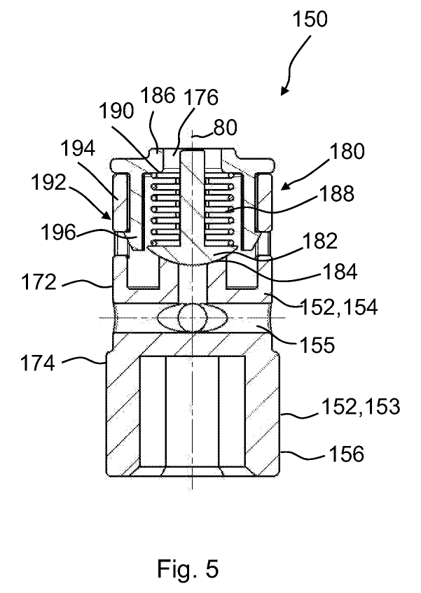

As seen for example in the section illustration of the drain closure element 150 of the filter system 100 in FIG. 5, the element body 152 of the drain closure element 150 comprises a connection part 153 and a centering part 154. In this context, the centering part 154 comprises the first seal surface 172 and the connection part 153 comprises the second seal surface 174. The drain closure element 150 comprises no seal and/or seal grooves. The sealing action is realized at the seal surfaces 172, 174 by the seal elements 32, 34, 36 attached to the filter element 10.

The element body 152 comprises furthermore a drain opening 176 which may be closed and/or is closed by a bypass valve 180. The bypass valve 180 may be formed at least partially as one piece together with the element body 152. Due to the bypass valve 180, the raw fluid, at high hydraulic pressure at the raw fluid side, may flow unfiltered through the drain closure element 150 and the bypass valve 180 integrated therein to the clean fluid side of the filter element 10 at the element interior 14 and in this way drain through the fluid outlet 104 of the filter system 100.

The bypass valve 180 comprises a valve body 182 which is linearly movable against a pressure spring 188 and which is pressed into a valve seat 184 by means of the pressure spring 188, wherein the pressure spring 188 is supported against a pressure surface 190 arranged at the element body 152.

The valve body 182 is guided at a linear guide 186 which is connected to the element body 152, for example molded to the element body 152. The linear guide 186, in turn, is fixedly connected to the centering part 154 of the drain closure element 150 and, for example, may be plugged into the centering part 154 and/or snapped onto the centering part 154. For this purpose, a connection element 196 of a connection 192, for example a snap connection 192, may be arranged at the linear guide 186 which interacts with a complementary connection element 194 arranged at the centering part 154.

The receiving section 22 and the connection part 153 of the element body 152 of the drain closure element 150 comprise fluid openings 23, 155, respectively, for flow-through of the raw fluid.

By hydraulic pressure of the raw fluid flowing through the fluid openings 23 of receiving section 22 and through the fluid openings 155 of connection part 153 into the element body 152, the valve body 182 may be lifted off its valve seat 184 against the restoring force of the pressure spring 188 and the bypass valve 180 may thus be opened. The raw fluid may then drain through the interior of the centering part 154 and the drain opening 176 into the element interior 14 of the filter element 10 and via the fluid outlet 104 of the filter housing 110.

Optionally, a drain channel 170 (see FIG. 3) guided to an exterior side 120 of the filter housing 110, when arranged as intended, may be present at the connection part 153. Via the drain channel 170, raw fluid contained in the filter housing 110 may drain after partial unscrewing of the drain closure element 150 out of the filter housing 110.

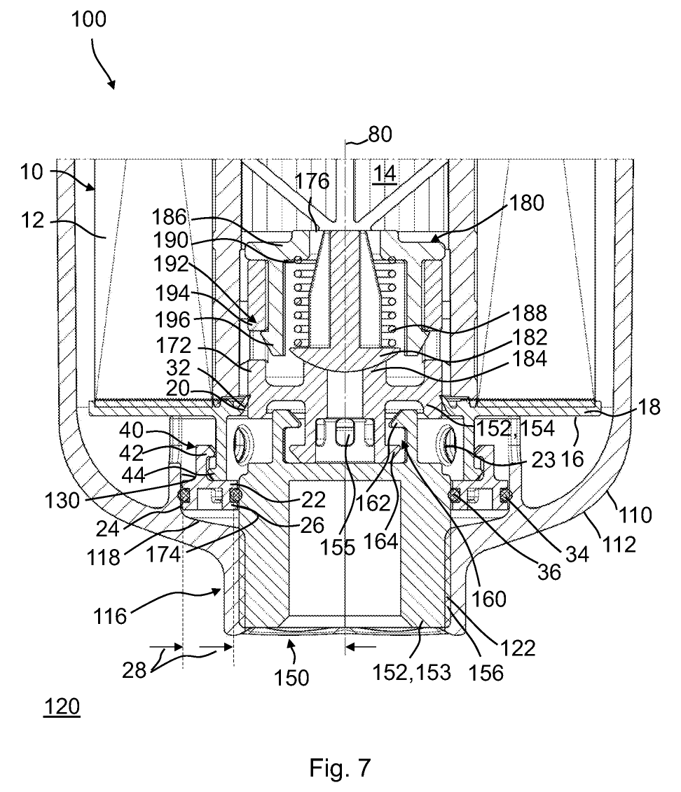

FIG. 6 shows a section illustration of a filter system 100 according to a further embodiment of the invention. In FIG. 7, an enlarged illustration of the region of the drain device 116 of the filter system 100 is illustrated.

The filter system 100 is configured similar to the filter system 100 illustrated in FIGS. 1 to 3. The difference is that relative movements of the filter element 10 against the filter housing 110 caused by pressure pulsations in filter operation are tolerated in the embodiment illustrated in FIGS. 6 and 7.

For this purpose, the receiving section 22 is connected to the end disc 18 so as to be movable, for example axially limited, along the longitudinal axis 80. The receiving section 22 and the end disc 18 comprise complementary connection elements 42, 44 of a connection 40, for example of a snap connection 40, which permits, for example an axially limited movement of the receiving section 22 along the longitudinal axis 80 relative to the end disc 18. When mounting the filter element 10, the receiving section 22 may snap into place with its connection element 42 at the connection element 44 arranged at the end disc 18.

Furthermore, the centering part 154 of the drain closure element 150 is connected so as to be movable, for example axially limited, along the longitudinal axis 80 in relation to the connection part 153. The connection part 153 and the centering part 154 comprise for this purpose complementary connection elements 162, 164, respectively, of a connection 160, for example of a snap connection 160, which permits, for example an axially limited movement of the centering part 154 along the longitudinal axis 80 relative to the connection part 153. When mounting the drain closure element 150, the connection part 153 with its connection element 162 may snap into place at the connection element 164 arranged on the centering part 154.

### Reference Characters

10 filter element

12 filter medium

13 support tube

14 element interior

16 end face

17 end face

18 end disc

19 end disc

20 element drain opening

22 receiving section

23 fluid openings

24 outer side

26 inner side

28 radial distance

32 first seal element

34 second seal element

36 third seal element

40 connection

42 connection element

44 connection element

80 longitudinal axis

100 filter system

102 fluid inlet

104 fluid outlet

110 filter housing

112 housing part

114 housing part

116 drain device

118 housing drain opening

120 exterior side

122 inner thread

124 screw thread

126 housing seal

130 seal surface

150 drain closure element

152 element body

153 connection part

154 centering part

155 fluid openings

156 outer thread

160 connection

162 connection element

164 connection element

170 drain channel

172 first seal surface

174 second seal surface

176 drain opening

180 bypass valve

182 valve body

184 valve seat

186 linear guide

188 pressure spring

190 pressure surface

192 connection

194 connection element

196 connection element

That which is claimed is:

1. A drain closure element for a filter system, the drain closure element comprising:
an element body configured to connect to a filter housing of the filter system by a rotation and/or plug-in movement in relation to a longitudinal axis; and
a bypass valve configured to close a drain opening of the element body.

2. The drain closure element according to claim 1, wherein the bypass valve comprises a valve body and a pressure spring, wherein the pressure spring is supported against a pressure surface arranged at the element body and wherein the valve body is pressed into a valve seat by the pressure spring, wherein the valve body is linearly movable against the pressure spring.

3. The drain closure element according to claim 1, wherein the element body comprises a first seal surface configured to seal against a seal element of an element drain opening of a filter element of the filter system and further comprises a second seal surface configured to seal against a seal element of a receiving section of the filter element.

4. The drain closure element according to claim 3, wherein the element body comprises a connection part and a centering part, wherein the centering part comprises the first seal surface and the connection part comprises the second seal surface.

5. The drain closure element according to claim 4, wherein the centering part is connected to the connection part so as to be moveable axially limited along the longitudinal axis.

6. The drain closure element according to claim 5, wherein the connection part and the centering part comprise complementary connection elements of a connection, wherein the connection permits an axially limited movement of the centering part relative to the connection part along the longitudinal axis.

7. A filter element for a filter system, the filter element comprising:
at least one filter medium surrounding an element interior and comprising an axial end face in relation to a longitudinal axis;
an end disc connected to the at least one filter medium at the axial end face;
wherein the end disc comprises an element drain opening connected in fluid communication to the element interior;
wherein the element drain opening comprises a first seal element surrounding the element drain opening and oriented radially inwardly;
wherein the element drain opening, when installed in a filter housing of the filter system, is closable and/or closed by a drain closure element comprising an element body connected to the filter housing of the filter system by a rotation and/or plug-in movement in relation to the longitudinal axis and comprising a bypass valve configured to close a drain opening of the element body;
wherein the first seal element is configured to seal-tightly contact a first seal surface of the drain closure element;
wherein the end disc comprises a receiving section configured to guide the drain closure element and circumferentially surround the drain opening of the element body;
wherein the receiving section comprises a second seal element which seal-tightly contacts a seal surface of the filter housing; and
wherein the receiving section comprises a third seal element configured to contact seal-tightly a second seal surface of the drain closure element.

8. The filter element according to claim 7, wherein the first seal element, the second seal element, and the third seal element are configured as radially sealing seal elements.

9. The filter element according to claim 7, wherein the second seal element is arranged at a radially outer side of the receiving section and the third seal element is arranged at a radially inner side of the receiving section.

10. The filter element according to claim 7, wherein the second seal element and the third seal element are arranged on a radially outer side of the receiving section.

11. The filter element according to claim 7, wherein one of the second seal element and the third seal element is arranged at a greater radial distance in relation to the longitudinal axis than the other one of the second seal element and the third seal element.

12. The filter element according to claim 7, wherein the second seal element is arranged between the first seal element and the third seal element along the longitudinal axis.

13. The filter element according to claim 7, wherein the second seal element and the third seal element are arranged at a same level of the longitudinal axis.

14. The filter element according to claim 7, wherein the receiving section is connected to the end disc so as to be movable axially limited along the longitudinal axis.

15. The filter element according to claim 14, wherein the receiving section and the end disc comprise complementary connection elements of a connection, wherein the connection permits an axially limited movement of the receiving section relative to the end disc along the longitudinal axis.

16. A filter system comprising:
a filter housing comprising at least one fluid inlet and at least one fluid outlet;
a filter element arranged in the filter housing such the filter element separates the at least one fluid inlet from the at least one fluid outlet;
a drain device configured to drain the fluid contained in the filter housing, wherein the drain device comprises at least one housing drain opening;
a drain closure element comprising an element body configured to connect to the filter housing by a rotation and/or plug-in movement in relation to a longitudinal axis and further comprising a bypass valve configured to close a drain opening of the element body;
wherein the filter element comprises at least one filter medium, surrounding an element interior and comprising an axial end face in relation to the longitudinal axis, and further comprises an end disc connected to the at least one filter medium at the axial end face;
wherein the end disc of the filter element comprises an element drain opening connected in fluid communication to the element interior; and
wherein the drain closure element closes the at least one housing drain opening and further closes the element drain opening of the end disc.

17. The filter system according to claim 16, wherein the element body of the drain closure element comprises a first seal surface configured to seal against a seal element of the element drain opening of the end disc of the filter element, and further comprises a second seal surface configured to seal against a seal element of a receiving section of the filter element.

18. The filter system according to claim 17, wherein the element body of the drain closure element comprises a connection part and a centering part, and wherein the centering part comprises the first seal surface and the connection part comprises the second seal surface.

19. The filter system according to claim 18, wherein the centering part is connected to the connection part so as to be movable axially limited along the longitudinal axis.

20. The filter system according to claim 19, wherein the connection part and the centering part comprise complementary connection elements of a connection, and wherein the connection permits an axially limited movement of the centering part along the longitudinal axis relative to the connection part.
